(19) United States
(12) Patent Application Publication
(10) Pub. No.: US 2008/0170165 A1
(43) Pub. Date: Jul. 17, 2008

(54) Reception Structure for Mobile Video and Audio Device

(76) Inventors: Mark Lee, Taipei (TW); Jang-Chang Wu, Taipei (TW); Wei-Yu Wu, Taipei (TW)

Correspondence Address: HDSL, 4331 STEVENS BATTLE LANE, FAIRFAX, VA, 22033, US

(21) Appl. No.: 11/623,745

(22) Filed: Jan. 16, 2007

(51) Int. Cl. H04N 5/64

(52) U.S. Cl. 348/837; 348/E05.128

(57) ABSTRACT

A reception structure for a video/audio device includes a machine box having a surface on which a display is mounted. The display has one side by which a CD-ROM having an end is mounted. The machine box is received within a reception box and the end of CD-ROM of the machine box is pushed out from the reception box so that a CD is allowed to be accessed with respect to the CD-ROM when a locking mechanism is loosened. The locking mechanism for fixing the machine box within the reception box and a spring-out mechanism for pushing out the end of the CD-ROM of the machine box are disposed between the machine box and the reception box.

### BACKGROUND OF THE INVENTION

1. Field of the Invention

The present invention relates to a reception structure for a mobile video and audio device. More particularly, the present invention relates to a reception structure for a mobile video and audio device, which has a simple design, saved space, aesthetic outline, convenience of operation and good portability.

2. Description of the Prior Art

With gradual promotion of the living standards, people tend to pay more attentions to recreations. Meanwhile, video and audio recreations have become part of the human's daily life. Particularly, it would be preferable to have some recreation when one stays in a car or bus during a business or holiday trip. Although reading may be a solution in this situation, the environment in the car is generally not pleasant for reading since it is dim and jerky. If some video and audio content is provided, a user can not only be comforted for the car time but also browse some information on the forthcoming seminar, meeting or something like that, so that the user can be provided with more time in preparing the related materials in the car.

As the currently available video and audio device used in a car is concerned, it is typically mounted on a headrest of a seat and digital versatile disks (DVDs) are used as storage therefor. However, the car has a limited space, which may form a problem for simultaneous access of the DVD and operation and viewing of the video and audio program. In fact, the conventional car use video and audio device has a complex structure, significant volume and weight, adding to a poor visual feeling to a passenger in the car. Further, the conventional car use video and audio device is difficult to be repaired and replaced and has a high cost.

For this, the inventor of the present invention sets forth a mobile video and audio device, which has a module-based structure comprising a simple fixing and springing-out mechanism so that it is relatively easier to be repaired and assembled. Meanwhile, the mobile video and audio device has a reduced dimension and volume and is thus enhanced in mobility and not limited in the mounted position. In addition, the mobile video and audio device is suitable to be widely used and has a lower cost.

### SUMMARY OF THE INVENTION

The present invention is to provide a reception structure for a mobile video and audio device, which has a module-based design and is thus advantageous in space arrangement, and is benefited in portability and use.

Another, the present invention is to provide a reception structure for a mobile video and audio device, which is light in weight and relatively lower in cost and is benefited with easy detachment and maintenance and not fragile.

Yet another, the present invention is to provide a reception structure for a mobile video and audio device, which is normally not exposed except a display portion without having an adverse effect on an outlook of a location around which it is positioned.

Still another, the present invention is to provide a reception structure for a mobile video and audio device, which may not only be mounted in a car but also in any kind of space so that the mobile video and audio device can be used at different positions at the same time, thereby reducing a cost thereof.

In accordance with the present invention, the reception structure for a video/audio device comprises a machine box having a surface on which a display is mounted. The display has one side by which a CD-ROM having an end is mounted. The machine box is received within a reception box and the end of CD-ROM of the machine box is pushed out from the reception box so that a CD is allowed to be accessed with respect to the CD-ROM when a locking mechanism is loosened. The locking mechanism for fixing the machine box within the reception box and a spring-out mechanism for pushing out the end of the CD-ROM of the machine box are disposed between the machine box and the reception box.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of a machine box according to the present invention;

FIG. 2 is a diagram of a reception structure for a video/audio device, with a relative position between the machine box and a reception box depicted, according to the present invention;

FIG. 3 is a diagram showing that the reception structure shown in FIG. 2 is mounted on a headrest of a seat in a car according to the present invention;

FIG. 4 is a diagram for illustrating how the machine box is sprung out according to the present invention;

FIG. 5 is a diagram for illustrating how the machine box is locked according to the present invention;

FIG. 6 is a diagram of an outlook of for the machine box when being sprung out according to the present invention; and

FIG. 7 is a diagram of an outlook of the machine box when being locked according to the present invention.

### DETAILED DESCRIPTION OF THE PREFERRED EMBODIMENT

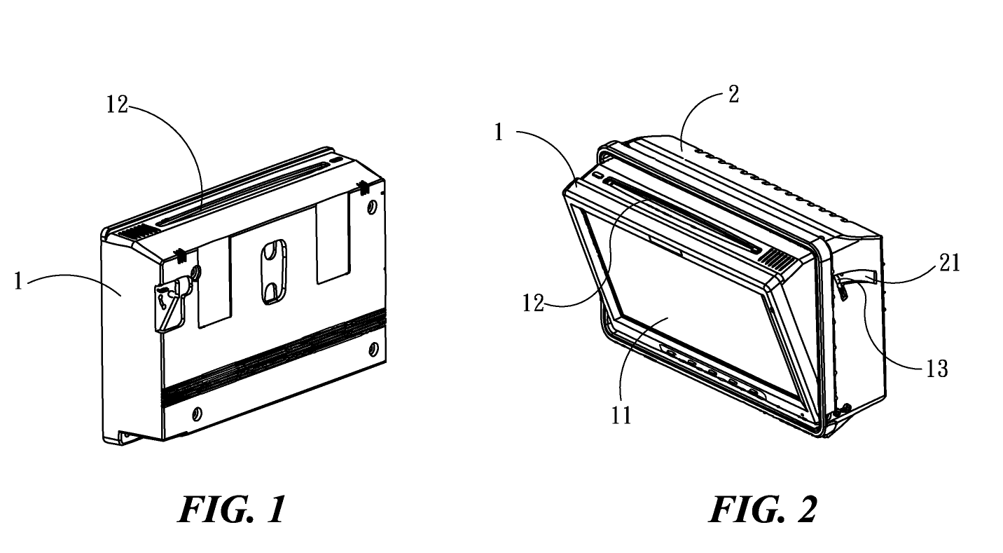

Referring to FIG. 1 and FIG. 2, a reception structure for a mobile video and audio device is shown therein. The mobile video and audio device has a machine box 1. The machine box 1 has a surface on which a display 11 for playing a video content is mounted. A CD-ROM 12 is mounted at an end of the machine box 1 and the CD-ROM 12 is an embedded CD-ROM. In the CD-ROM 12, a DVD may be operated to play a video and audio content. In the machine box 1, there are also some circuits including a control circuit for control of playing of the mobile video and audio device, which will be omitted herein.

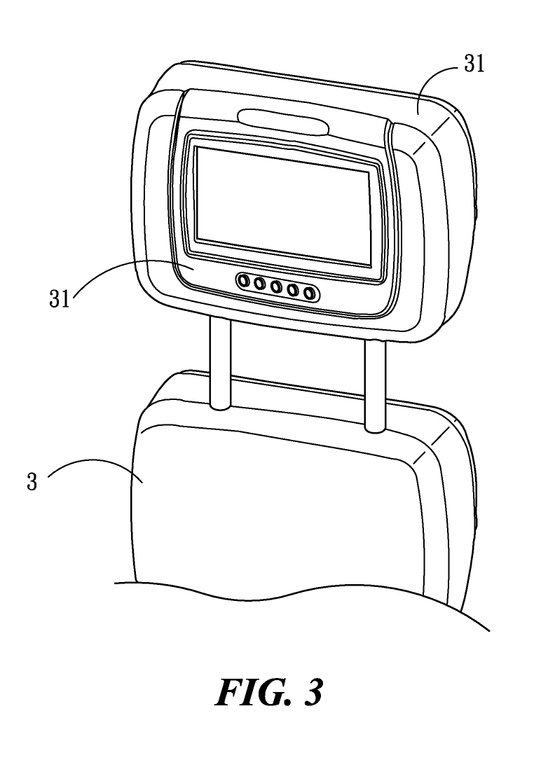

Referring to FIG. 3, in which the reception structure of a mobile video and audio device according to the present invention is shown as being mounted in a car. As shown, the mobile video and audio device at rear of a headrest of a seat 3 in the car. Since a space for accommodation of the mobile video and audio device is limited, a spacial arrangement of the mobile video and audio device is particularly important. To solve this problem, a reception box 2 is mounted in the headrest 31 for accommodation of the machine box 1. At normal time, the machine box is totally enclosed by the reception box 2. When the DVD has to be placed into or taken out from the CD-ROM 12, the machine box 1 is pushed out from the reception box 2, so that an opening portion of the CD-ROM 12 is exposed for placement or take-out from the DVD.

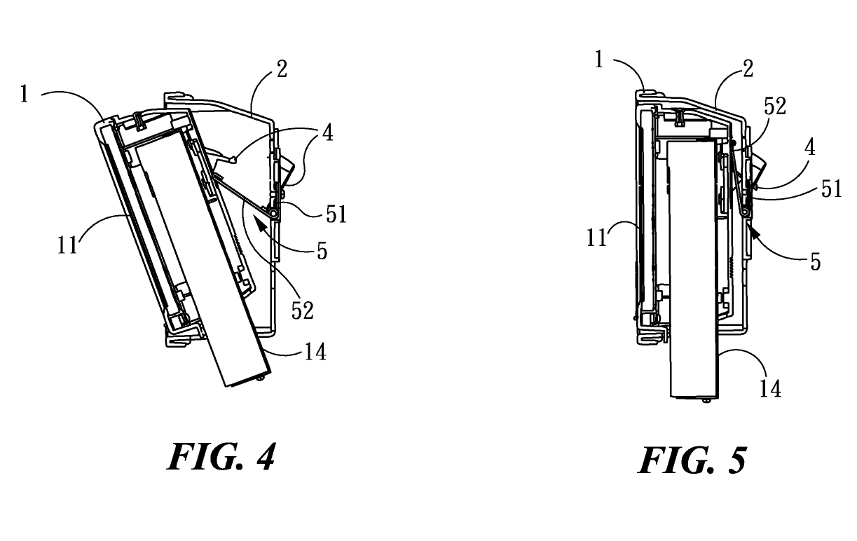

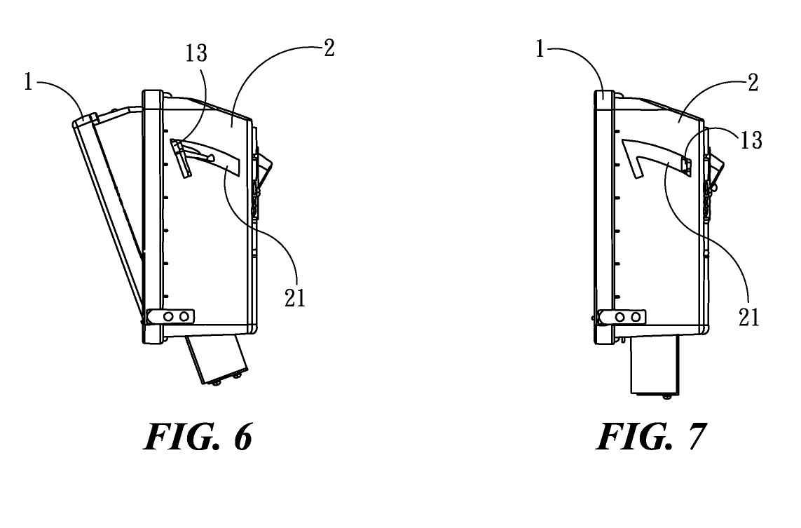

Referring to FIG. 4 through FIG. 7, in which mechanisms for springing out and fixing the machine box 1 and outlooks of the machine box when being sprung out and fixed are shown. A locking mechanism 4 and a springing-out mechanism 5 each having a machine box portion and a reception box portion are disposed on the machine box 1 and the reception box 2, respectively, with the machine box portion and the reception box portion disposed opposedly to each other. The locking mechanism 4 may be any fastening member such as a hook and a tenor. When the machine box 1 is withdrawn to within the reception box 2, the locking mechanism 4 is replied on to fix the machine box 1 in place. When the locking mechanism 4 is loosened, the machine box 1 can be pushed out from the reception box 2. As a matter of fact, the locking mechanism may be any mechanism equivalent to those exemplified above and not limited to be any particular form herein.

The springing-out mechanism 5 has a fixed end 51, which is fixed on the reception box 2 and connected to a springing-out end 52 contacted with the machine box 1. When the locking mechanism 4 is loosened, the springing-out mechanism 5 is relied on to push the machine box 1 out from the reception box 2, so that the DVD can be placed into or taken out from the CD-ROM 12. Likewise, the springing-out mechanism 5 may be any equivalent to that exemplified above and not limited to any form herein.

Further, a recess 21 is formed on two sides of the reception box 2, respectively. And a fixing piece 13 is disposed on two sides of the machine box 1, respectively, at a position corresponding to a position where the associated recess 21 is formed on the reception box 2. The fixing piece 13 is placed deep into the recess 21, with which the machine box 1 can be confined within and guided along a predetermined path when being pushed out from the reception box 2. In addition, a distance at which the machine box 1 is pushed out can be limited by an end of the recess 21. Further, a stop 14 is also formed on a side near the CD-ROM 12, which extends outwardly. When the CD-ROM 12 is pushed out from the reception box 2, it urges against the reception box 2 by the stop 14, effectively limiting the distance at which the machine box 1 is pushed out.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A reception structure for a video/audio device comprising a machine box having a surface on which a display is mounted, the display having one side by which a CD-ROM having an end is mounted, the machine box being received within a reception box and the end of CD-ROM of the machine box being pushed out from the reception box so that a CD is allowed to be accessed with respect to the CD-ROM when a locking mechanism is loosened, characterized in that:
the locking mechanism for fixing the machine box within the reception box and a spring-out mechanism for pushing out the end of the CD-ROM of the machine box are disposed between the machine box and the reception box.

2. The reception structure as claimed in claim 1, wherein the locking mechanism comprises a hook and a tenor.

3. The reception structure as claimed in claim 1, wherein the spring-out mechanism has a fixed end fixed on the reception box and a spring-out end contacting with the machine box and springing out the machine box out from the reception box.

4. The reception structure as claimed in claim 1, wherein the reception box has two sides each having a recess thereon and the machine box has two sides each having a fixing piece thereon so that the fixing piece urges against the recess to limit a distance at which the machine box is pushed out.

5. The reception structure as claimed in claim 1, wherein the machine box has a side near the CD-ROM and a stop extending outwardly so as to limit a distance at which the CD-ROM is pushed out.

6. The reception structure as claimed in claim 1, wherein the CD-ROM is an embedded CD-ROM.
